(19) United States
(12) Patent Application Publication
(10) Pub. No.: US 2021/0184189 A1
(43) Pub. Date: Jun. 17, 2021

(54) BATTERY STACK AND BATTERY MODULE EMPLOYING BATTERY STACK

(71) Applicant: TOYOTA JIDOSHA KABUSHIKI KAISHA, Toyota-shi (JP)

(72) Inventors: Akihiro YANAI, Toyota-shi (JP); Masahiro SAKATA, Toyota-shi (JP)

(73) Assignee: TOYOTA JIDOSHA KABUSHIKI KAISHA, Toyota-shi (JP)

(21) Appl. No.: 17/085,455

(22) Filed: Oct. 30, 2020

(30) Foreign Application Priority Data
Dec. 12, 2019 (JP) 2019-224461

(51) Int. Cl. H01M 2/10; H01M 2/02; H01M 10/655

(52) U.S. Cl. CPC H01M 2/1077; H01M 10/655; H01M 2/024

(57) ABSTRACT

A battery stack including: plural battery cells that have been waterproofed, that are arrayed along a horizontal direction, and that each has a length direction running in a direction orthogonal to an array direction of the battery cells; and plural resin frames that are respectively provided between mutually adjacent battery cells, that support both length direction end portions of the battery cells, and that form an opening that exposes lower faces of the battery cells.

### CROSS-REFERENCE TO RELATED APPLICATION

This application is based on and claims priority under 35 USC 119 from Japanese Patent Application No. 2019-224461 filed on Dec. 12, 2019, the disclosure of which is incorporated by reference herein.

### BACKGROUND

### Technical Field

The present disclosure relates to a battery stack and a battery module employing this battery stack.

### Related Art

The battery module described in Japanese Patent Application Laid-Open (JP-A) No. 2017-201587 is provided with a lower face case that houses battery cells configuring part of a battery stack. The lower face case is capable of housing the battery cells individually, and covers outer faces of the battery cells. Moreover, an exposing portion to expose the battery cells is locally formed in the lower face case. An external cooling device or coolant contacts the battery cells through this exposing portion to enable the battery cells to be cooled.

However, in JP-A No. 2017-201587, an external cooling device or coolant is required in order to cool the battery cells, complicating the battery stack. There is accordingly further room for improvement with regard to battery stack heat dissipation measures.

### SUMMARY

In consideration of the above circumstances, an object of the present disclosure is to obtain a battery stack and a battery module employing this battery stack that are capable of improving heat dissipation performance with a simple structure for plural battery cells applied with waterproofing measures.

A battery stack according to a first aspect of the present disclosure includes plural battery cells that have been waterproofed, that are arrayed along a horizontal direction, and that each has a length direction running in a direction orthogonal to an array direction of the battery cells; and plural resin frames that are respectively provided between mutually adjacent battery cells, that support both length direction end portions of the battery cells, and that form an opening that exposes lower faces of the battery cells.

The battery stack according to the first aspect of the present disclosure is configured including the plural battery cells and the plural resin frames. The battery cells are applied with waterproofing measures, arrayed along the horizontal direction, and have their length direction running in a direction orthogonal to the array direction.

The resin frames are respectively provided between mutually adjacent of the battery cells, support both the length direction end portions of the battery cells, and form the opening that exposes the lower faces of the battery cells.

Namely, lower walls of the resin frames may for example be configured by a pair of support portions that support both the length direction end portions of the battery cells, and the opening may be formed between the support portions. The lower faces of the battery cells are thus exposed through the opening at regions other than both the length direction end portions of the battery cells.

Thus, in the present disclosure, the battery cells applied with waterproofing measures can be cooled from the lower face side of the battery cells through the opening formed in the resin frames. This enables a battery stack to be obtained in which heat dissipation performance is improved with a simple structure applied with waterproofing measures.

A battery stack according to a second aspect of the present disclosure is the battery stack according to the first aspect, wherein each of the resin frames includes: a rectangular, plate-shaped body disposed between mutually adjacent battery cells; a pair of sidewalls provided at both length direction ends of the body so as to be capable of abutting both length direction ends of one of the mutually adjacent battery cells; and a pair of support portions that are bent to follow the horizontal direction from lower ends of the sidewalls so as to support, and abut lower faces of both length direction end portions of, the one of the mutually adjacent battery cells.

In the battery stack according to the second aspect of the present disclosure, each of the resin frames is configured including the body, the pair of sidewalls, and the pair of support portions. The body has a rectangular plate shape and is disposed between the mutually adjacent battery cells. The pair of sidewalls are provided at both the length direction ends of the body so as to be capable of abutting both the length direction ends of the corresponding battery cell.

The pair of support portions are bent to follow the horizontal direction from the lower ends of the sidewalls so as to abut the lower faces of both the length direction end portions of the corresponding battery cell and be capable of supporting the battery cell. Namely, the opening is formed in each of the resin frames between leading ends of the support portions, and the lower face of the corresponding battery cell is exposed through this opening.

A battery stack according to a third aspect of the present disclosure is the battery stack according to the second aspect, further including a reference face-opposing face that is provided at one sidewall of the pair of sidewalls and that is formed with a biasing portion to bias the one of the mutually adjacent battery cells toward another sidewall of the pair of sidewalls; and a reference face that is provided at the other sidewall so as to be abutted by one length direction end portion of the one of the mutually adjacent battery cells, wherein of the pair of support portions, a length of one support portion formed on one sidewall side is set so as to be longer than a length of another support portion formed on another sidewall side.

In the battery stack according to the third aspect of the present disclosure, the biasing portion is formed to the one sidewall out of the pair of sidewalls of each of the resin frames, and the corresponding battery cell is biased toward the other sidewall out of the pair of sidewalls by the biasing portion.

The reference face that is abutted by the one length direction end portion of the battery cell is provided to the other sidewall, and the one sidewall includes the reference face-opposing face. The length of the one support portion formed on the one sidewall side is set so as to be longer than the length of the other support portion formed on the other sidewall side.

As described above, the pair of support portions of the resin frame respectively support both the length direction end portions of the corresponding battery cell. Thus, increasing an overlap amount between the support portions and the battery cell improves the support strength with which the battery cell is supported. On the other hand, increasing the overlap amount between the support portions and the battery cell decreases the area of the opening that exposes the lower face of the battery cell, with the result that cooling performance of the battery cell could suffer.

Thus, in the present disclosure, first, the one sidewall of each of the resin frames is provided with the biasing portion that biases the battery cell toward the other sidewall, such that the one length direction end portion of the battery cell abuts the reference face of the other sidewall. Thus, out of the pair of support portions, the overlap amount on the one support portion side (reference face-opposing face side) is smaller than that on the other support portion side (reference face side).

In cases in which the overlap amount between a support portion of the resin frame and the battery cell is small, the support strength offered to the battery cell by the support portion might be insufficient, such that the battery cell might slip from the support portion. This would be detrimental to the positional precision of the lower face of the battery cell.

Thus, in the present disclosure, the length of the one support portion on the reference face-opposing face side is set so as to be longer than the length of the other support portion on the reference face side. The present disclosure thereby enables the overlap amount with the battery cell to be secured on the one support portion side where the overlap amount would otherwise be smaller. Namely, in the present disclosure, support strength is ensured on the one support portion side where the overlap amount with the battery cell would otherwise be smaller, enabling the positional precision of the lower face of the battery cell to be improved.

Only the length of the one support portion is set so as to be longer in order to secure the overlap amount with the battery cell. This suppresses narrowing of a separation distance between the leading ends of the support portions, enabling the opening area in the resin frame to be maintained. Accordingly, in the present disclosure, the overlap amount between the resin frames and the battery cells is secured, while the exposed area of the lower faces of the battery cells is also secured by maintaining the opening area in the resin frames, enabling a drop in the cooling efficiency of the battery cells to be suppressed.

A battery module according to a fourth aspect of the present disclosure includes the battery stack of any one of the first to the third aspect; and a housing case in which the battery stack is housed in a waterproofed state, and that is provided with a heatsink to dissipate heat passing through the lower faces of the battery cells, which has been generated by the battery cells.

The battery module according to the fourth aspect of the present disclosure includes the battery stack and the housing case, and the battery stack is housed in the housing case in a state applied with waterproofing measures. The housing case is provided with the heatsink to dissipate heat passing through the lower faces of the battery cells that was generated by the battery cells.

As described above, the battery stack of the first aspect of the present disclosure exhibits an excellent advantageous effect of enabling heat dissipation performance to be improved with a simple structure for plural battery cells applied with waterproofing measures.

The battery stack of the second aspect of the present disclosure exhibits an excellent advantageous effect of enabling the opening to be provided in the resin frames that support the battery stacks, such that heat from the battery cells can be dissipated through the opening.

The battery stack of the third aspect of the present disclosure exhibits excellent advantageous effects of enabling the support strength of the battery stack by the resin frames to be secured, and enabling a drop in the cooling efficiency of the battery cells to be suppressed.

The battery module of the fourth aspect of the present disclosure exhibits an excellent advantageous effect of enabling heat dissipation performance to be improved with a simple structure for plural battery cells applied with waterproofing measures.

### BRIEF DESCRIPTION OF THE DRAWINGS

Exemplary embodiments of the present disclosure will be described in detail based on the following figures, wherein:

FIG. 1 is a cross-section illustrating a battery stack and a housing case configuring parts of a battery module according to an exemplary embodiment of the present disclosure;

FIG. 2 is a perspective view illustrating a battery stack configuring part of a battery module according to an exemplary embodiment of the present disclosure, as viewed from an oblique lower side;

FIG. 3 is a is a perspective view illustrating a battery stack and a housing case configuring parts of a battery module according to an exemplary embodiment of the present disclosure;

FIG. 4 is a perspective view illustrating a state in which a battery stack configuring part of a battery module according to an exemplary embodiment of the present disclosure is housed in a housing case;

FIG. 5 is a perspective view illustrating battery cell and a resin frame configuring parts of a battery stack according to an exemplary embodiment of the present disclosure;

FIG. 6 is an enlarged cross-section of relevant portions to illustrate a positional relationship in a height direction between battery cells configuring parts of a battery stack according to an exemplary embodiment of the present disclosure and a bottom wall of a housing case;

FIG. 7 is a graph comparing distances from a bottom wall face of a bottom wall of a housing case at a reference face-opposing face side and a reference face side of a battery cell configuring part of a battery stack according to an exemplary embodiment of the present disclosure;

FIG. 8A and FIG. 8B are comparative examples relating to FIG. 8C; and

FIG. 8C is a side view schematically illustrating a resin frame and a battery cell configuring parts of a battery stack according to an exemplary embodiment of the present disclosure.

### DETAILED DESCRIPTION

Explanation follows regarding a battery stack 12 according to an exemplary embodiment of the present disclosure, with reference to the drawings.

Note that in the drawings, the arrow UP, the arrow L, and the arrow W respectively indicate an upward direction, a length direction, and a width direction of a battery module 10 according to the present exemplary embodiment, as appropriate.

### Battery Module Configuration

First, explanation follows regarding configuration of the battery module 10 according to the present exemplary embodiment of the present disclosure.

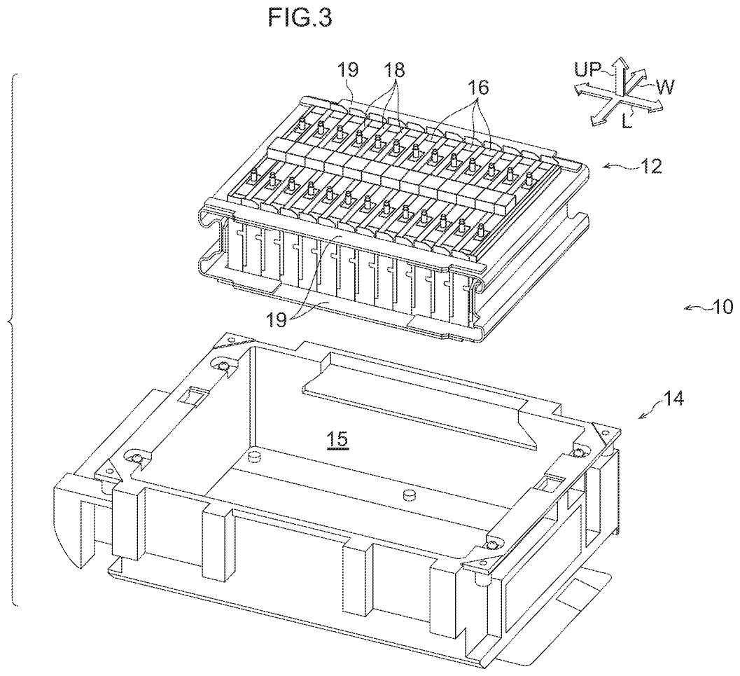

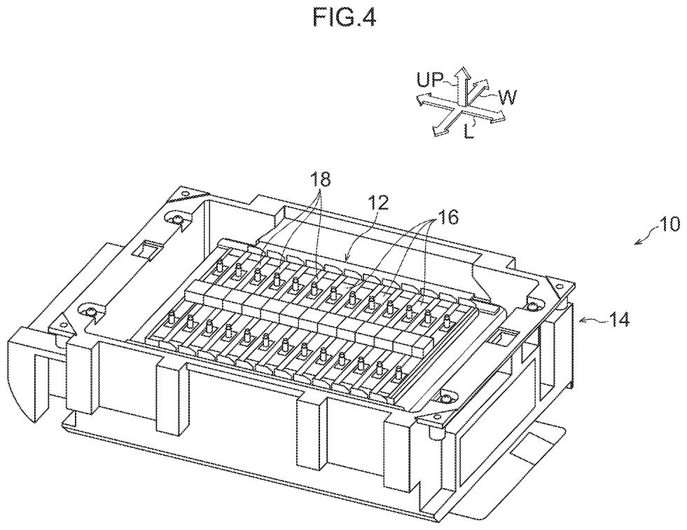

As illustrated in FIG. 3, in the present exemplary embodiment, the battery module 10 includes the battery stack 12 and a housing case 14. As illustrated in FIG. 4, the battery stack 12 is housed inside the housing case 14.

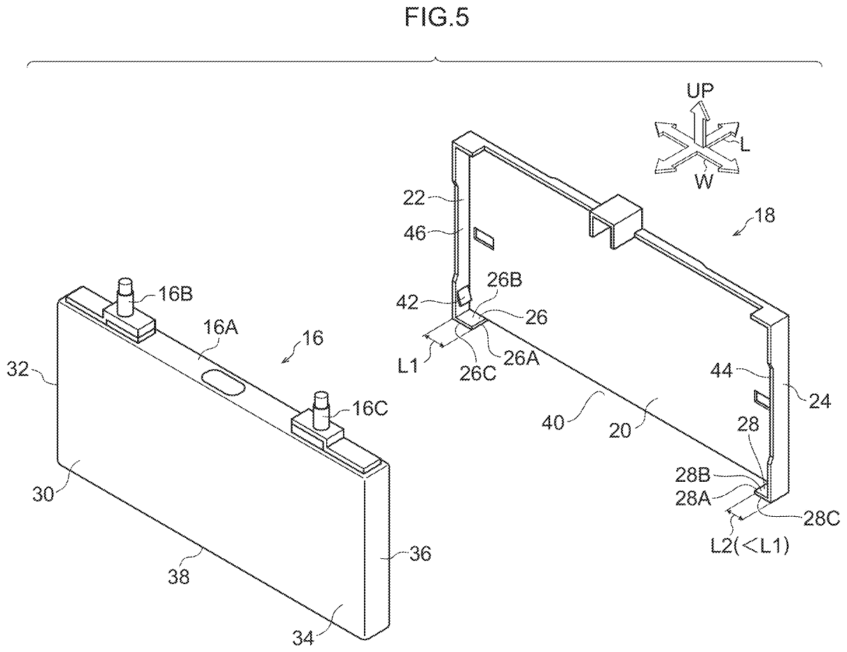

As illustrated in FIG. 3 and FIG. 5, the battery stack 12 is configured including plural battery cells 16 and plural resin frames 18. Each of the battery cells 16 has a flattened rectangular block shape, and the plural battery cells 16 are arrayed along a width direction of the battery cells 16, this being orthogonal to a length direction of the battery cells 16. The plural battery cells 16 are arranged along a horizontal direction. Note that the battery cells 16 are applied with waterproofing measures.

Each of the battery cells 16 is, for example, a rechargeable battery capable of being charged and discharged, and may, for example, be a rechargeable lithium ion battery. The battery cells 16 are angular batteries with a flattened rectangular block shape. Note that there is no limitation to rechargeable lithium ion batteries, and the battery cells 16 may be another type of battery, such as rechargeable nickel-hydrogen batteries.

An upper face 16A of each of the battery cells 16 is provided with a positive terminal 16B and a negative terminal 16C, each terminal having a circular column shape. The battery cells 16 are arrayed such that the orientations of the positive terminal 16B and the negative terminal 16C are arranged alternately in the length direction of the battery stack 12 (array direction of the battery cells 16, arrow L direction). The positive terminals 16B and the negative terminals 16C of mutually adjacent battery cells 16 in the length direction of the battery stack 12 are connected to each other through a non-illustrated bus bar, this being a conductive member.

The resin frames 18 are disposed between the mutually adjacent battery cells 16. Namely, the battery stack 12 is configured with an alternating array of the battery cells 16 and the resin frames 18. The resin frames 18 are, for example, formed from a resin such as polypropylene, and are disposed as insulating members between the respective battery cells 16.

In this alternating array of the battery cells 16 and the resin frames 18, the battery cells 16 and the resin frames 18 are applied with pressure along the array direction of the battery cells 16 by pressure-application bands 19 disposed at both length direction end portions and above and below the respective battery cells 16. This maintains inter-particle ionic conductivity in the electrolytic material, thereby maintaining battery performance of the battery stack 12.

As illustrated in FIG. 5, each of the resin frames 18 is configured including a body 20, a pair of sidewalls 22, 24, and a pair of support portions 26, 28. The body 20 is formed in a rectangular plate shape, and is disposed between the mutually adjacent battery cells 16. The respective sidewalls 22, 24 are provided at both length direction ends of the body 20. The respective sidewalls 22, 24 jut out from side ends of the body 20.

Accordingly, in a state in which the body 20 of a given resin frame 18 is adjacent to a corresponding battery cell 16, a sidewall face 32 provided at one length direction end portion 30 of the battery cell 16 is capable of abutting one the sidewalls of the resin frame 18, namely the sidewall 22, while a sidewall face 36 provided at another length direction end portion 34 of the battery cell 16 is capable of abutting the other sidewall of the resin frame 18, namely the sidewall 24.

The respective support portions 26, 28 extend from lower ends of the sidewalls 22, 24 of the resin frame 18 so as to be contiguous to the body 20 and bend toward directions approaching each other. The support portions 26, 28 are abutted by a lower face 38 of the battery cell 16, and both the length direction end portions 30, 34 of the battery cells 16 are respectively supported by the support portions 26, 28.

Namely, in the present exemplary embodiment, an opening 40 is formed between a leading end 26A of one of the support portions, namely the support portion 26, and a leading end 28A of the other of the support portions, namely the support portion 28. The lower face 38 of the battery cell 16 is capable of being exposed through the opening 40.

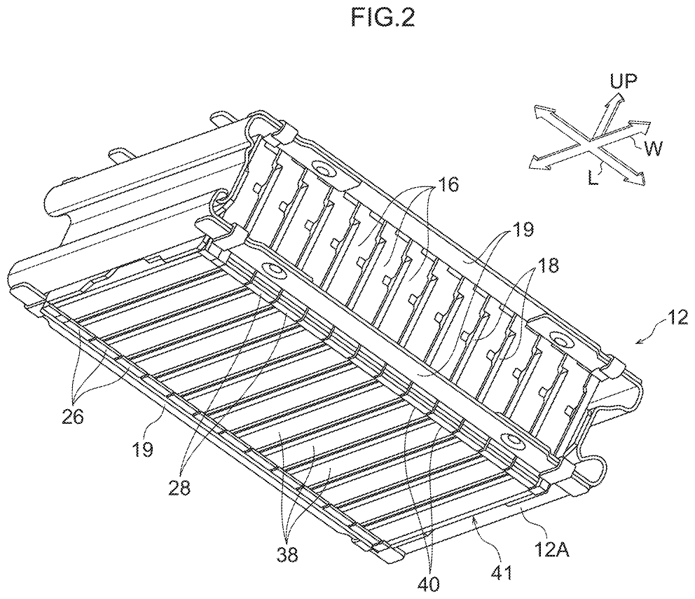

As illustrated in FIG. 2, the openings 40 are formed so as to be contiguous to one another along the array direction of the battery cells 16. Accordingly, a lower portion 12A of the battery stack 12 is formed with a large opening 41 formed by the contiguous openings 40.

Moreover, as illustrated in FIG. 5, the sidewall 22 of each of the resin frames 18 is provided with a lip (biasing portion) 42 opposing the sidewall 24. The lip 42 biases the battery cell 16 toward the sidewall 24 in a state in which the battery cell 16 is being supported by the resin frame 18.

The sidewall face 36 of the battery cell 16 accordingly abuts the sidewall 24 of the resin frame 18. A face of the sidewall 24 of the resin frame 18 that is abutted by the sidewall face 36 of the battery cell 16 in this manner is referred to as a reference face 44, and a face on the sidewall 22 side of the resin frame 18 is referred to as a reference face-opposing face 46.

FIG. 3 is a perspective view illustrating the battery stack 12 and the housing case 14 configuring parts of the battery module 10. As illustrated in FIG. 3, the housing case 14 is box shaped, and is open at an upper side. The housing case 14 is formed of die-cast aluminum or the like, and as illustrated in FIG. 4, the battery stack 12 is housed inside a housing area 15 of the housing case 14.

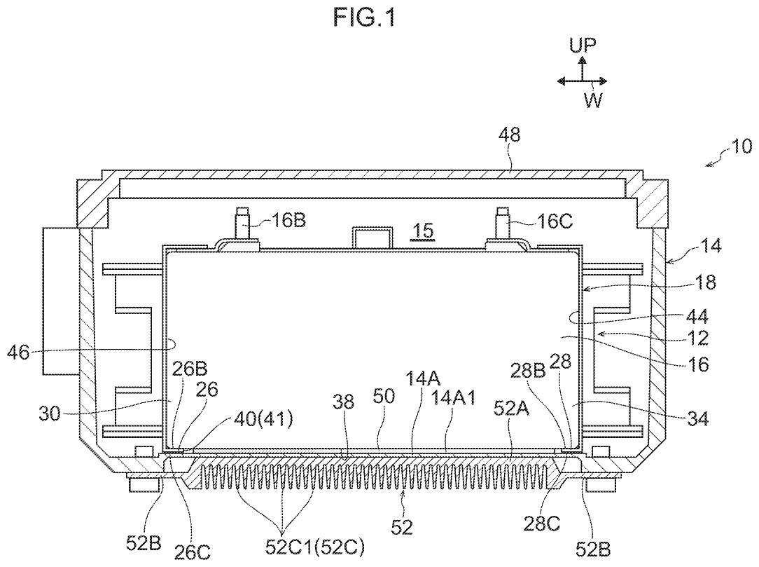

In a state in which the battery stack 12 is housed inside the housing case 14 in this manner, a cover 48 is fixed to the housing case 14 as illustrated in FIG. 1. Note that FIG. 1 is a cross-section illustrating the battery module 10.

As illustrated in FIG. 1, a non-illustrated sealing member is provided between the cover 48 and the housing case 14, and the battery stack 12 is housed inside the housing case 14 in a sealed state. Moreover, in the housed state of the battery stack 12 inside the housing case 14, the battery stack 12 is placed on a bottom wall 14A of the housing case 14.

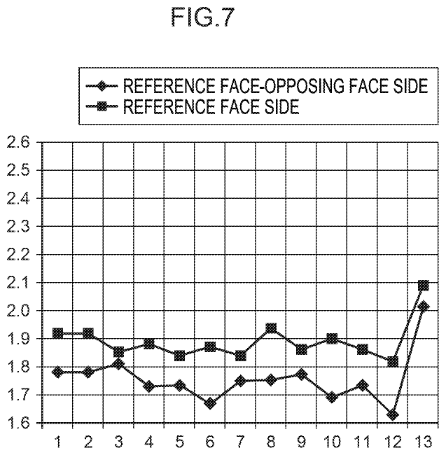

Note that FIG. 7 is a graph illustrating a comparison between distances from a bottom wall face 14A1 of the bottom wall 14A of the housing case 14 on the one length direction end portion 30 side of the battery cells 16 (the reference face-opposing face 46 side) and the other length direction end portion 34 side of the battery cells 16 (the reference face 44 side).

As illustrated in FIG. 7, the distance from the bottom wall face 14A1 of the bottom wall 14A of the housing case 14 is shorter on the reference face-opposing face 46 side of the battery cells 16 illustrated in FIG. 1 than on the reference face 44 side of the battery cells 16. Namely, the reference face-opposing face 46 side of the battery cells 16 hangs further toward a lower side than the reference face 44 side of the battery cells 16.

Accordingly, in the present exemplary embodiment, as illustrated in FIG. 5, a length L1 of the support portions 26 is set so as to be longer than a length L2(<L1) of the support portions 28, such that the one length direction end portions 30 of the battery cells 16 are reliably supported by the support portions 26.

In the present exemplary embodiment, as illustrated in FIG. 1, the bottom wall 14A of the housing case 14 is coated with heat dissipation grease 50. The heat dissipation grease 50 is thus interposed between the battery stack 12 and the housing case 14 when the battery stack 12 is placed on the bottom wall 14A of the housing case 14.

As described above, the battery cells 16 are supported by the support portions 26, 28 of the respective resin frames 18, and the lower faces 38 of the battery cells 16 are in a state contacting upper faces 26B of the respective support portions 26 and upper faces 28B of the respective support portions 28.

Strictly speaking, height differences thereby emerge between the lower faces 38 of the battery cells 16 and lower faces 26C of the support portions 26, and also between the lower faces 38 of the battery cells 16 and lower faces 28C of the support portions 28. Accordingly, in the present exemplary embodiment, the heat dissipation grease 50 is coated at a thickness that is set in advance so as to absorb these height differences.

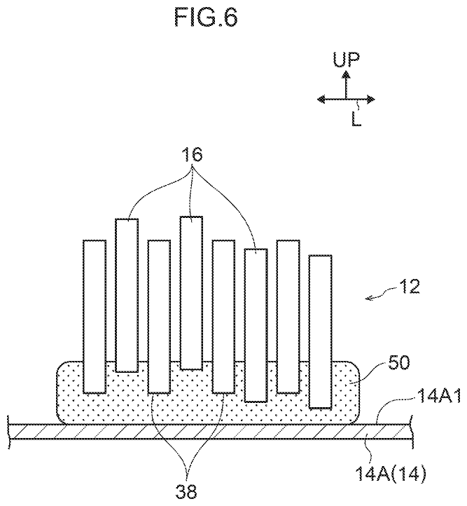

FIG. 6 is an enlarged cross-section illustrating relevant portions in order to illustrate a positional relationship between the battery cells 16 and the bottom wall 14A of the housing case 14 in the height direction. As illustrated in FIG. 6, in an arrayed state of the plural battery cells 16, when the battery cells 16 are viewed from the one length direction ends of the battery cells 16, variation in the region of several μm to around a dozen μm arises between the height direction positions of the lower faces 38 of the battery cells 16. The heat dissipation grease 50 is thereby set with a coating thickness that takes this variation into consideration. The lower faces 38 of the battery cells 16 accordingly contact the heat dissipation grease 50 reliably.

Moreover, as illustrated in FIG. 1, in the present exemplary embodiment, a heatsink 52 is attached to the bottom wall 14A of the housing case 14 on the outer side of the housing case 14. The heatsink 52 is formed from a metal with good thermal conductivity, such as aluminum or ferrous metal.

The heatsink 52 is configured including a plate shaped base 52A that makes face-to-face contact with the bottom wall 14A of the housing case 14, fixing portions 52B that are fixed to the housing case 14, and a fin section 52C that hangs downward from the base 52A.

The fin section 52C is formed by plural elongated plate shaped fins 52C1 that extend along the array direction of the battery cells 16. The fins 52C1 are arranged at a predetermined pitch along the length direction of the resin frames 18 of the battery cells 16. Note that the pitch of the fins 52C1 is set as small as possible in order to increase the surface area of the heatsink 52.

### Operation and Advantageous Effects of Battery Module

Explanation follows regarding operation and advantageous effects of the battery module 10 according to an exemplary embodiment of the present disclosure.

As illustrated in FIG. 2 and FIG. 5, in the present exemplary embodiment, the opening 40 is formed in each of the resin frames 18 provided between mutually adjacent battery cells 16 in the battery stack 12. The opening 40 is formed between the leading end 26A of the support portion 26 and the leading end 28A of the support portion 28 that are bent toward mutually approaching directions from the lower ends of the sidewalls 22, 24 of the resin frame 18.

The lower faces 38 of the battery cells 16 are thus exposed through the openings 40 at regions other than both the length direction end portions 30, 34 of the battery cells 16. In the present exemplary embodiment, the plural battery cells 16 are arrayed along the length direction of the battery stack 12. Accordingly, the lower portion 12A of the battery stack 12 is formed with the large opening 41 formed by the contiguous openings 40. The battery cells 16 can accordingly be cooled from the lower face 38 side of the battery cells 16 through the large opening 41.

Namely, in the present exemplary embodiment, the battery cells 16 applied with waterproofing measures can be cooled through the large opening 41 formed by the contiguous openings 40 that expose regions at the lower faces 38 of the battery cells 16 other than both the length direction end portions 30, 34 of the battery cells 16. This thereby enables the heat dissipation performance of the battery cells 16 to be improved by a simple structure.

Note that as illustrated in FIG. 1, in the present exemplary embodiment, the bottom wall 14A of the housing case 14 is coated with the heat dissipation grease 50, and the battery stack 12 is placed on the bottom wall 14A of the housing case 14 such that the heat dissipation grease 50 is interposed between the battery stack 12 and the bottom wall I 4A. The heatsink 52 is provided to the bottom wall 14A of the housing case 14 on the outside of the housing case 14.

More specifically, in the present exemplary embodiment, the lower faces 38 of the battery cells 16 contact the heat dissipation grease 50 coated on the bottom wall 14A of the housing case 14, and the base 52A of the heatsink 52 is in face-to-face contact with the bottom wall 14A of the housing case 14.

Accordingly, in the present exemplary embodiment, heat from the battery cells 16 is transmitted in sequence through the lower faces 38 of the battery cells 16, the heat dissipation grease 50, the bottom wall 14A of the housing case 14, and the base 52A of the heatsink 52. Namely, in the present exemplary embodiment, a thermal conductance path is secured between the battery cells 16, the heat dissipation grease 50, the housing case 14, and the heatsink 52, enabling heat emitted from the battery cells 16 to be dissipated via the fin section 52C of the heatsink 52.

As described above, in the present exemplary embodiment, the heat dissipation grease 50 is provided between the lower faces 38 of the battery cells 16 and the bottom wall 14A of the housing case 14 so as to achieve a setting in which the heat from the battery cells 16 is transmitted to the bottom wall 14A side of the housing case 14 through the heat dissipation grease 50.

Note that as illustrated in FIG. 6, since in the present exemplary embodiment variation in the region of from several μm to around a dozen μm emerges in the height direction positions of the lower faces 38 of the battery cells 16 in a state in which plural of the battery cells 16 are arrayed, the coating thickness of the heat dissipation grease 50 is set in advance in consideration of this variation. The present exemplary embodiment is thus set such that the lower faces 38 of the battery cells 16 reliably contact the heat dissipation grease 50.

Moreover, as illustrated in FIG. 1, the base 52A of the heatsink 52 makes face-to-face contact with the outside of the bottom wall 14A of the housing case 14. Namely, in the present exemplary embodiment, no gaps are formed between the battery cells 16, the heat dissipation grease 50, and the heatsink 52. The present exemplary embodiment thus enables the battery cells 16 to be effectively cooled while suppressing cooling loss.

As illustrated in FIG. 5, in the present exemplary embodiment, the support portions 26, 28 of the resin frames 18 support both the length direction end portions 30, 34 of the respective battery cells 16. As a general rule, increasing the overlap amount between the support portions 26, 28 and the battery cells 16 improves the support strength with which the battery cells 16 are supported.

On the other hand, increasing the overlap amount between the support portions 26, 28 and the battery cells 16 decreases the area of the openings 40 that expose the lower faces 38 of the battery cells 16, with the result that cooling performance of the battery cells 16 could suffer.

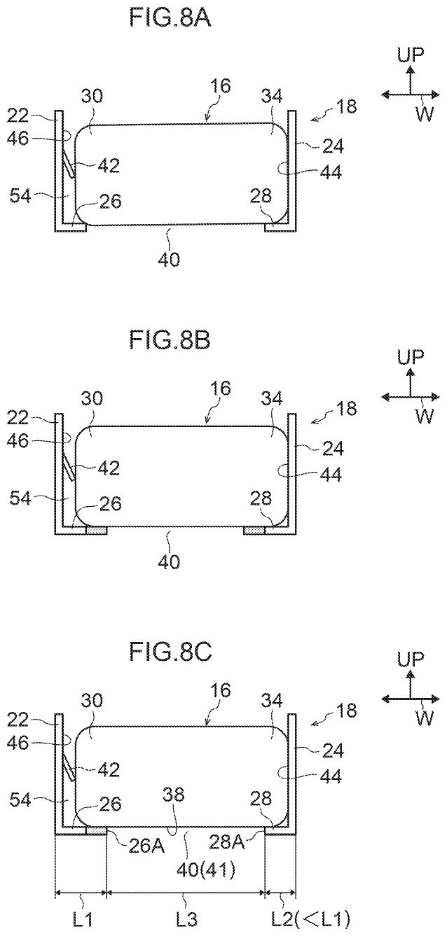

Accordingly, in the present exemplary embodiment, the sidewall 22 of each of the resin frames 18 is provided with the lip 42 that biases the corresponding battery cell 16 toward the sidewall 24, such that the other length direction end portion 34 of the battery cell 16 abuts the reference face 44 of the sidewall 24. A gap 54 (see FIG. 8C) is thus formed between the reference face-opposing face 46 provided to the sidewall 22 of the resin frame 18 and the one length direction end portion 30 of the battery cell 16.

FIG. 8A illustrates a comparative example in which the overlap amounts between the pair of support portions 26, 28 and the battery cell 16 are set such that the overlap amount with the battery cell 16 on the support portion 26 side (reference face-opposing face 46 side) is smaller than that on the support portion 28 side (reference face 44 side).

In such cases in which the overlap amount between the support portion 26 of the resin frame 18 and the battery cell 16 is small, the support strength offered to the battery cell 16 by the support portion 26 might be insufficient, such that the battery cell 16 might slip from the support portion 26. This would be detrimental to the positional precision of the lower face 38 of the battery cell 16.

FIG. 8B illustrates a comparative example for the purpose of examining a case in which the overlap amounts between the support portions 26, 28 and the battery cell 16 are increased. In this case, although the support strength with which the battery cell 16 is supported is improved, there is a commensurate decrease in the area of the opening 40 that exposes the lower face 38 of the battery cell 16. This might result in a drop in the cooling performance of the battery cell 16.

Accordingly, in the present exemplary embodiment, out of the pair of support portions 26, 28, the length L1 of the support portion 26 formed on the sidewall 22 side is set so as to be longer than the length L2(<L1) of the support portion 28 formed on the sidewall 24 side.

As illustrated in FIG. 8C, the present exemplary embodiment thereby enables the overlap amount with the battery cell 16 to be secured on the support portion 26 side where the overlap amount would otherwise be smaller. As a result, support strength is ensured on the support portion 26 side where the overlap amount with the battery cell 16 would otherwise be smaller, enabling the positional precision of the lower face 38 of the battery cell 16 to be improved.

In the present exemplary embodiment, only the length L1 of the support portion 26 is set so as to be longer in order to secure the overlap amount with the battery cell 16 at the support portion 26 (on the reference face-opposing face 46 side). This suppresses narrowing of a separation distance L3 between the leading end 26A of the support portion 26 and the leading end 28A of the support portion 28, enabling the opening area to be maintained.

Accordingly, in the present exemplary embodiment, the overlap amount between the resin frames 18 and the battery cells 16 is secured, while the exposed area of the lower faces 38 of the battery cells 16 is also maintained, enabling a drop in the cooling efficiency of the battery cells 16 to be suppressed.

Note that in the present exemplary embodiment, setting the length L1 of the support portion 26 longer than the length L2 of the support portion 28 secures the overlap amount with the battery cell 16 on the support portion 26 side. However, there is no limitation thereto as long as the battery cell 16 can be prevented from slipping from the support portion 26.

For example, the surface frictional coefficient on the support portion 26 side may be increased, for example by applying surface roughening, to discourage the battery cell 16 from slipping from the support portion 26.

In the present exemplary embodiment, the support portions 26, 28 extend from the respective lower ends of the sidewalls 22, 24 so as to be contiguous to the body 20 of the resin frame 18. However, it is sufficient that both the length direction end portions 30, 34 of the battery cells 16 be supported by the support portions 26, 28. Accordingly, as long as the support portions 26, 28 are capable of ensuring the required rigidity, the support portions 26, 28 do not necessarily need to be contiguous to the body 20. Namely, there is no need for width dimensions of the support portions 26, 28 to be substantially the same as a width direction dimension of the battery cell 16.

Although explanation has been given regarding one example of an exemplary embodiment of the present disclosure, various modifications may be implemented within a range not departing from the spirit of the present disclosure. Obviously, the scope of rights encompassed by the present disclosure is not limited to the exemplary embodiment described above.

What is claimed is:

1. A battery stack comprising:
a plurality of battery cells that have been waterproofed, that are arrayed along a horizontal direction, and that each has a length direction running in a direction orthogonal to an array direction of the battery cells; and
a plurality of resin frames that are respectively provided between mutually adjacent battery cells, that support both length direction end portions of the battery cells, and that form an opening that exposes lower faces of the battery cells.

2. The battery stack of claim 1, wherein each of the resin frames comprises:
a rectangular, plate-shaped body disposed between mutually adjacent battery cells;
a pair of sidewalls provided at both length direction ends of the body so as to be capable of abutting both length direction ends of one of the mutually adjacent battery cells; and
a pair of support portions that are bent to follow the horizontal direction from lower ends of the sidewalls so as to support, and abut lower faces of both length direction end portions of, the one of the mutually adjacent battery cells.

3. The battery stack of claim 2, further comprising:
a reference face-opposing face that is provided at one sidewall of the pair of sidewalls and that is formed with a biasing portion to bias the one of the mutually adjacent battery cells toward another sidewall of the pair of sidewalls; and
a reference face that is provided at the other sidewall so as to be abutted by one length direction end portion of the one of the mutually adjacent battery cells, wherein
of the pair of support portions, a length of one support portion formed on one sidewall side is set so as to be longer than a length of another support portion formed on another sidewall side.

4. A battery module comprising:
the battery stack of claim 1; and
a housing case in which the battery stack is housed in a waterproofed state, and that is provided with a heatsink to dissipate heat passing through the lower faces of the battery cells, which has been generated by the battery cells.

5. The battery module of claim 4, further comprising heat dissipation grease provided at a bottom wall of the housing case, wherein
the battery stack is placed at the bottom wall of the housing case such that the heat dissipation grease is interposed between the battery stack and the bottom wall.

6. The battery module of claim 5, wherein:
the heat dissipation grease is coated at a thickness that offsets a height difference between the lower faces of the battery cells and lower faces of support portions at one length direction end and a height difference between the lower faces of the battery cells and lower faces of the support portions at another length direction end.
